(19) United States
(12) Patent Application Publication
(10) Pub. No.: US 2015/0260387 A1
(43) Pub. Date: Sep. 17, 2015

(54) NIGHT LIGHTING SYSTEM, METHOD AND COMPONENT KIT

(71) Applicant: Bruce Gamble, Bethesda, MD (US)

(72) Inventor: Bruce Gamble, Bethesda, MD (US)

(21) Appl. No.: 14/657,145

(22) Filed: Mar. 13, 2015

Related U.S. Application Data
(60) Provisional application No. 61/952,360, filed on Mar. 13, 2014.

(51) Int. Cl. F21V 23/04; F21V 17/10; F21V 7/00; F21S 8/00; F21V 11/14

(52) U.S. Cl. CPC F21V 23/0471; F21S 8/035; F21V 11/14; F21V 7/0091; F21V 17/105; F21W 2121/00

(57) ABSTRACT

A night lighting device includes a battery powered motion activated lighting unit enclosed within a housing. The housing has walls with light apertures permitting light to escape and provide low level floor illumination. A front panel is pivotally attached to the housing. The front panel has an open peripheral frame and a rear wall set back from an edge of the frame. The open frame extends forwardly from and surrounds the rear wall. The rear wall includes light apertures and a sensor aperture. The open frame focuses the directivity of the motion sensor pattern due to the set back of the rear wall. The top overhang and side extensions of the frame prevent the motion sensing field from dispersing upwardly and laterally. Additionally, a kit is provided which includes the motion activated lighting device, a separate motion sensing lighting unit, and other components.

### CROSS REFERENCE TO RELATED APPLICATIONS

The present application is a non-provisional application based on and claiming priority from U.S. Provisional Application No. 61/952,360, entitled “Night Lighting System, Method and Component Kit”, filed Mar. 13, 2014, the disclosure which is hereby incorporated herein by reference in its entirety.

### FIELD OF THE INVENTION

The present invention pertains generally to night lighting systems and methods, and to a night lighting kit containing components to effect the systems and methods of the invention. More particularly, the invention is primarily concerned with providing motion activated supplemental lighting for use by persons in dark environments, particularly unfamiliar environments such as a room in a hotel, inn, or guest house, to facilitate ease in traversing a path from a bed to the bathroom and from the bathroom back to the bed. The invention may also be used in one's own home environment.

### BACKGROUND OF THE INVENTION

Individuals on travel experience a need for supplemental night lighting in dark unfamiliar environments to facilitate their ease of maneuvering from one place to another. This is especially true in commercial establishments, such as hotels, and guest houses, where guests of such establishments may find themselves unfamiliar with their room surroundings and could have trouble maneuvering around the room without lighting, particularly when they attempt to navigate from a bed they are occupying to the bathroom and back again to the bed in the dark unfamiliar environment.

While it is well known to utilize an individual light or sets of lights that are operated by a wall-mounted switch or a switch incorporated into a stand-alone lamp, often the fixed location of the switch or lamp is inconvenient or problematic based on factors like the age or physical condition of the user, and the conditions in the environment of use. For example, a person, particularly an elderly person, may be disoriented when arising in the dark such that finding a light switch may be difficult. Likewise, a child may have difficulty finding a light switch at night should he or she need to go to the bathroom, become scared or choose to leave his or her bed for other reasons due to unfamiliarity with the room or poor room design. Even where sufficient light may be available to locate the switch, a disabled individual may have difficulty physically reaching the switch location.

### SUMMARY OF THE INVENTION

Accordingly, it is an object of the present invention to provide a motion activated lighting device to assist persons in maneuvering safely in a dark unfamiliar environment. Aspects of the present invention are appropriate for both in-home applications and use while on travel.

It is another object of the present invention to assist persons to walk in darkened rooms thereby avoiding accidents by providing a motion activated lighting device which turns on alight to illuminate a floor level path after sensing motion of a person, thereby eliminating the need to illuminate the entire room.

It is a further object of the present invention to provide a night lighting system which provides illumination without the need for any actions by a person other than moving within the floor-level sensing range of a motion sensor used to illuminate a lighting unit.

Still another object of the present invention is to provide unique housing for a lighting device having a built-in motion sensor for activating a light source and keeping the light source activated for as long as motion is being detected within the sensor's range. The housing includes walls with multiple light apertures permitting light from the housed light source to escape the housing and provide a low level of illumination on the floor in the vicinity of the housing.

Yet another object of the present invention is to provide a lighting kit with multiple components including a housing enclosing a battery powered motion activated lighting unit, a separate motion sensing night light unit, curtain clips, bags, and instructions for using the components within the lighting kit.

In one aspect, the housing enclosing the motion activated lighting unit of the night lighting system may be placed under a bed or night stand adjacent the bed. However, the housing containing the lighting unit does not need to be placed under any structure so as long as the motion sensing pattern of the motion sensor detects only motion along the floor and the motion activated lighting device does not shine emitted light upward to startle or disturb room occupants.

In one embodiment of the present invention, the housing includes a front panel with a recessed wall portion set back from a peripheral edge of the front panel. The recessed wall portion includes a sensor aperture for accommodating the motion sensor of the lighting unit. The directivity pattern and range of the motion sensor is limited by the set back of the sensor aperture from the peripheral edge of the front panel—the greater the set back, the more directivity provided by the walls of the housing projecting forwardly of the sensor aperture.

Other aspects and advantages of the disclosure will be apparent to those skilled in the art on reviewing the drawings referenced below and reading the following detailed description.

### BRIEF DESCRIPTION OF THE DRAWINGS

The above mentioned and other features of this invention, and the manner of attaining them, will become more apparent and the invention itself will be better understood by reference to the following description of an embodiment of the invention taken in conjunction with the accompanying drawings, wherein like components are designated by like reference numerals.

FIG. 1 is a front perspective view from above, left, of a motion actuated lighting device according to one aspect of the present invention.

FIG. 2 is a front perspective view from above, right, of the device of FIG. 1.

FIG. 3 is a rear perspective view from above, right, of the device of FIG. 1.

FIG. 4 is a rear perspective view from above, left, of the device of FIG. 1.

FIG. 5 is a front perspective view from below, left, of the device of FIG. 1.

FIG. 6 is a perspective view from above, right, of the device of FIG. 1 with its front panel in an open position.

FIG. 7 is a perspective view from above, left, of the device of FIG. 1 with its front panel in an open position.

FIG. 8 is a perspective view from above, right, of the device of FIG. 1 shown upside down with its front panel in an open position.

FIG. 9 is a perspective view from above, right, of the device of FIG. 1 with its front panel in an open position.

FIG. 10 is a perspective view from below, left, of the device of FIG. 1 with its front panel in an open position.

FIG. 11 is a perspective view from above, left, of the device of FIG. 1 with its front panel in an open position, and its motion activated lighting unit removed.

FIG. 12 is a perspective view from below, right, of a motion activated lighting unit utilized in the device of FIG. 1.

FIG. 13 is a left side view in elevation of the motion activated lighting unit of FIG. 12.

FIG. 14 is a perspective view from above of a kit comprising components of a system of the present invention.

FIG. 15 is an exploded perspective view of the individual components of the system according to the present invention.

FIG. 16 is a schematic plan view of a bed with a motion activated lighting device of the present invention positioned under one side of the bed.

FIG. 17 is a schematic plan view of a bed with a motion activated lighting device of the present invention positioned under each side of the bed.

FIG. 18 is a schematic plan view of a bed and a night stand with a motion activated lighting device of the present invention positioned under the night stand.

FIG. 19 is a schematic plan view of a motion activated lighting device of the present invention positioned on the floor adjacent a bed.

FIG. 20 is a schematic view of a floor plan in a home, hotel, inn, or guest room with a motion actuated lighting device of the present invention positioned under one side of a bed and a motion sensing night light unit plugged into a wall mounted electrical outlet in a bathroom.

### DETAILED DESCRIPTION OF THE INVENTION

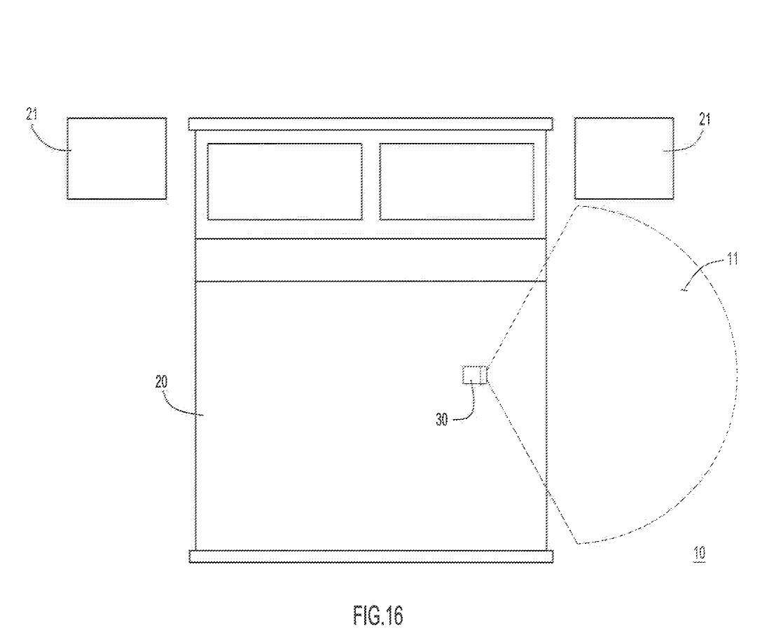

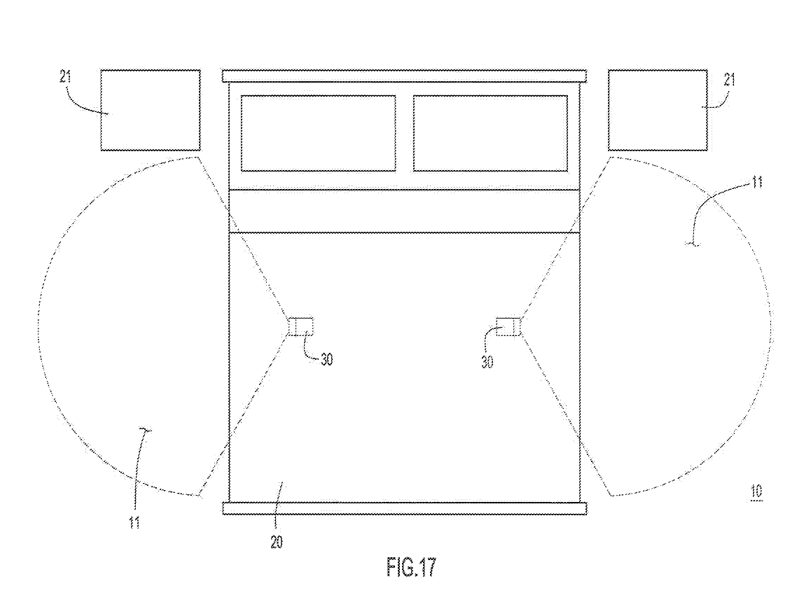

In accordance with the principles of the invention, in response to detected motion, such as by a person placing his/her foot on or near the floor 10 and suspended adjacent a side of a bed 20, the floor is illuminated by one or more bedside lighting devices 30. The bedside lighting devices 30 are preferably (but not necessarily) battery operated and have a built-in motion sensor such that the field or area of sensed motion 11 encompasses a portion of the floor adjacent the bed 20. The pattern of the field of sensed motion 11 (illustrated via broken lines in FIGS. 16-19) is typically a sector of a circle. Ideally, the motion sensor is positioned such that the field of sensed motion is focused outwardly from the side of the bed. In this way, the motion sensor will not be activated every time someone moves in the bed. Moreover, by having the sensor pointing away from the bed, it will not pick up movement of the covers which occurs as a normal part of the dynamics of a person sleeping as they move around in the bed. Thus, the room will stay darkened until an occupant of the bed begins to arise and places his/her feet into the arc-shaped field being sensed by the motion sensor.

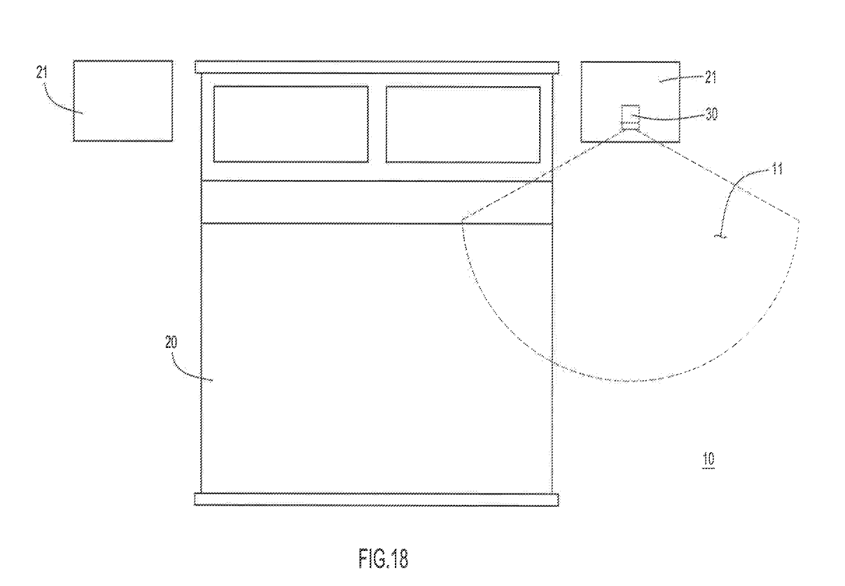

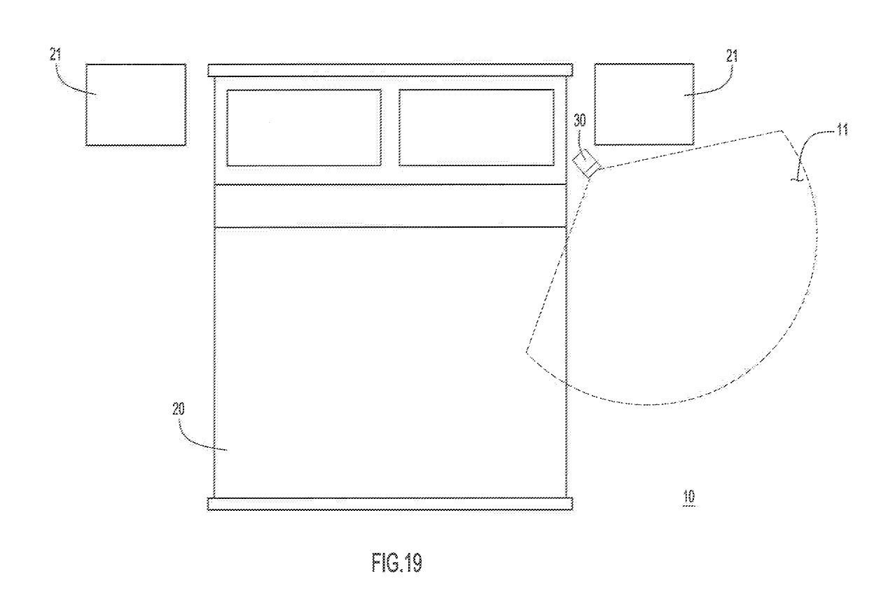

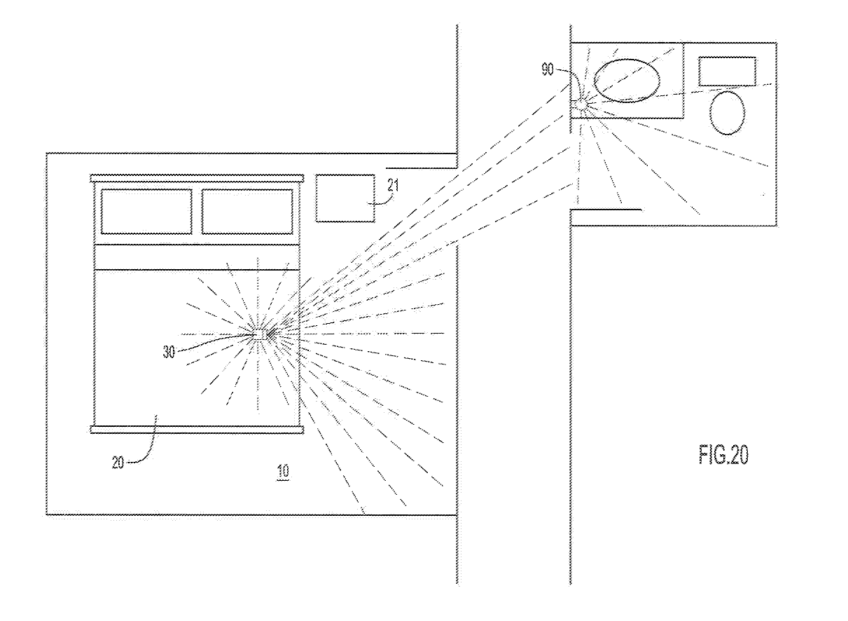

A lighting device 30 may be placed on the floor 10 under one or both sides of the bed 20 to illuminate the floor area near and beyond the bed. For example, see FIGS. 16-17 and 20. Specifically, FIGS. 16 and 20 illustrate the placement of lighting device 30 under the bed 20 when there is typically only one person occupying the bed, while FIG. 17 shows the placement of multiple lighting devices 30 where there are two occupants of the bed. The second lighting device 30 usually functions in a manner similar to the first lighting device—just on the opposite side of the bed. Alternatively, as shown in FIG. 18, a lighting device 30 may be placed on the floor under a night stand 21 adjacent a side of the bed to be illuminated. While not illustrated, a lighting device 30 may be placed on the floor beneath each of the night stands 21 shown in FIG. 18), if needed. Likewise, a lighting device 30 may be placed on the floor in proximity (preferably close proximity) to the side of the bed 20 to be illuminated, as shown in FIG. 19, to provide a low to the ground illuminated path. Additionally, one or more of the lighting devices 30 may be placed along a pathway from the bed to a bathroom, a child's room, or other location, e.g., a hallway, to not only provide a low to the ground illuminated path for the user to follow, but to provide a measure of safety while the user negotiates the darkened room environment. However, the specific placement of one or more of the lighting devices 30 may be best determined by each user based on individual need or through trial and error. For example, if the bed is a platform bed, the user would probably decide to place the lighting device 30 adjacent the side of the bed since there is no available space under the bed for placement of the lighting device. Similarly, if the bed has a dust ruffle, the user would most likely determine that placement of the lighting unit under the bed would be counterproductive since the dust ruffle would interfere with the field of sensed motion. Moreover, while the pattern of light emitted from lighting device 30 has only been shown in FIG. 20, it should be appreciated that light will emanate in a similar light pattern from the lighting units 30 shown in FIGS. 16-19.

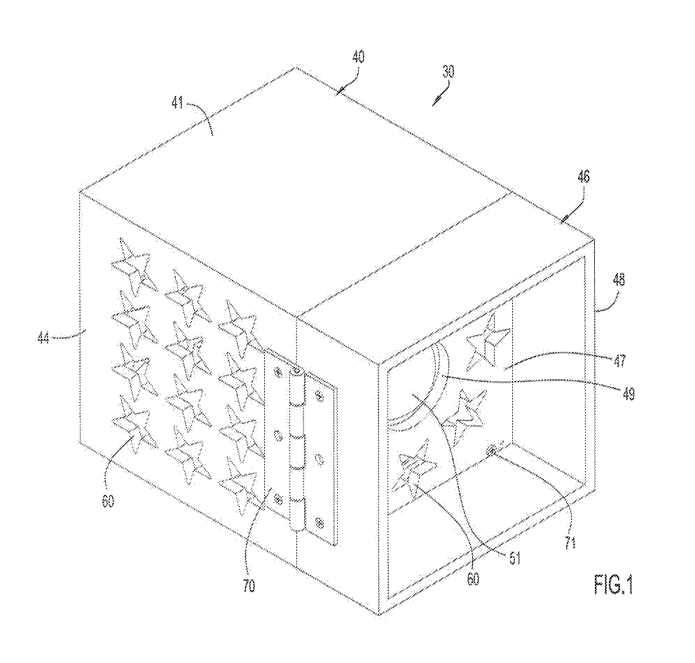

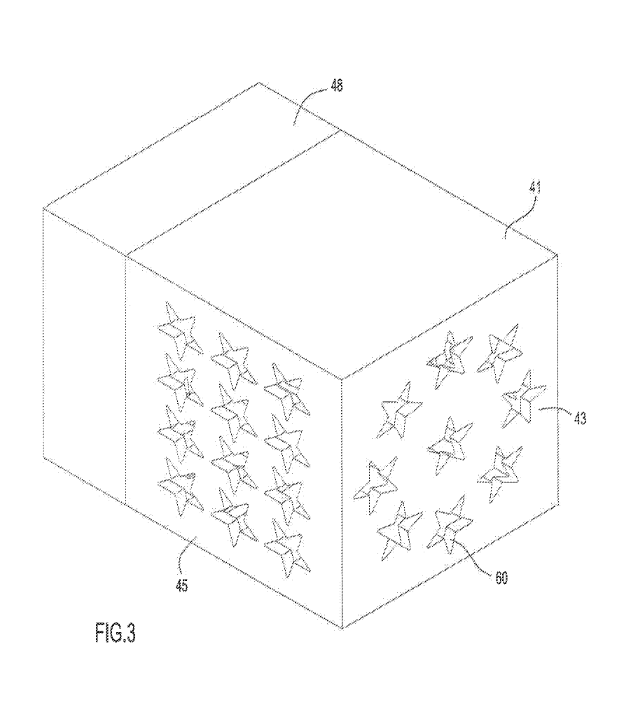

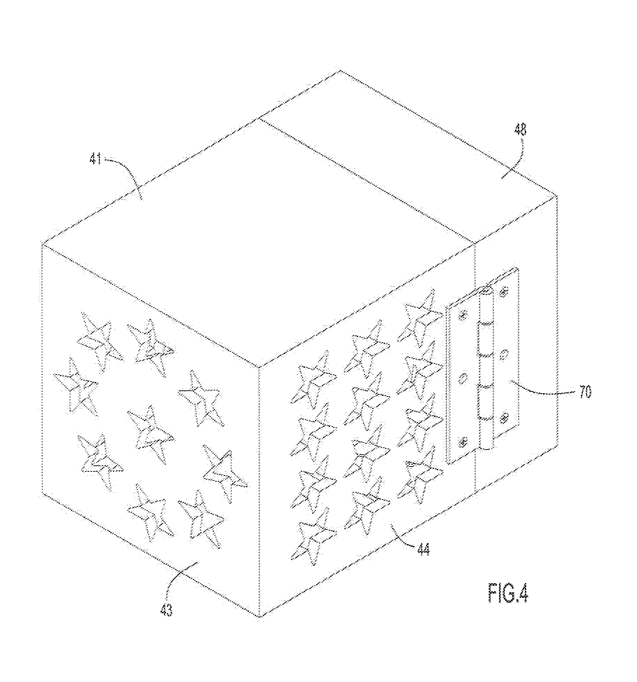

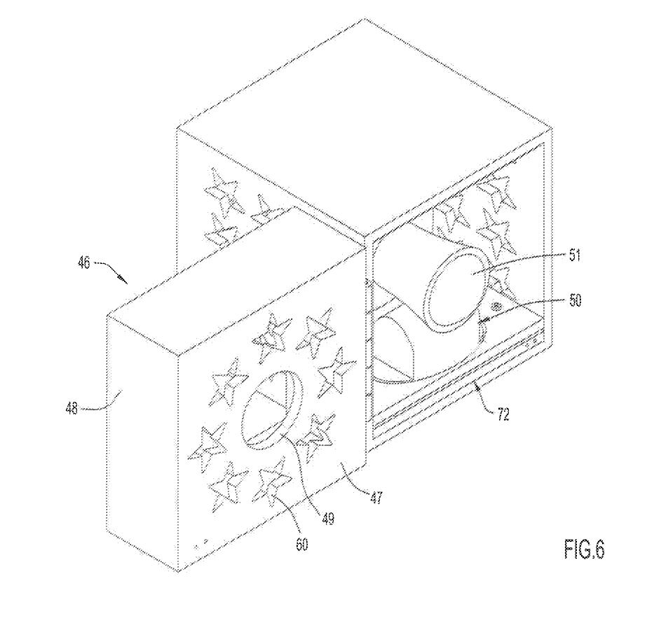

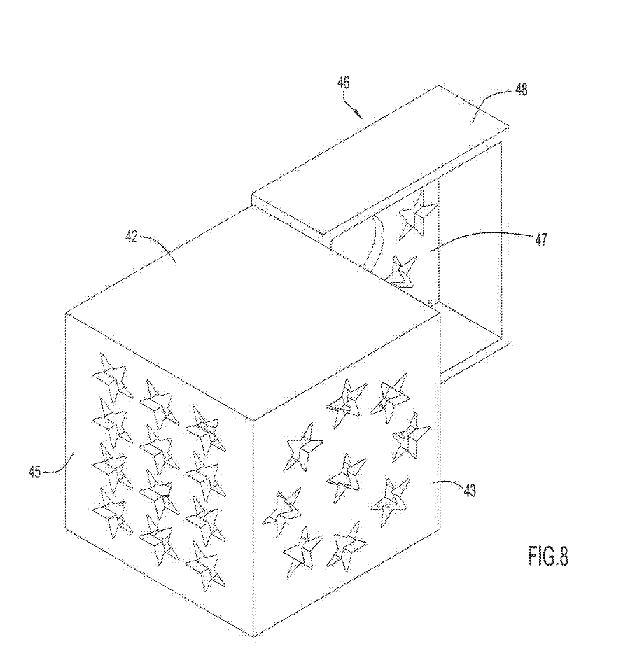

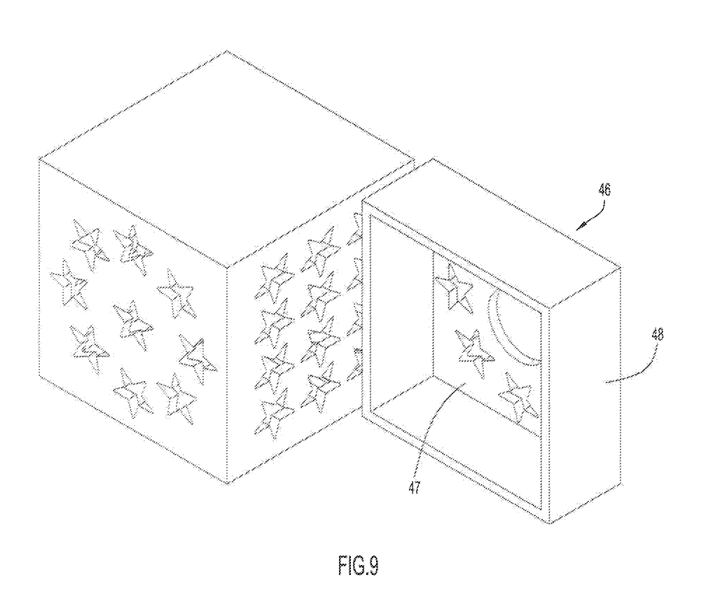

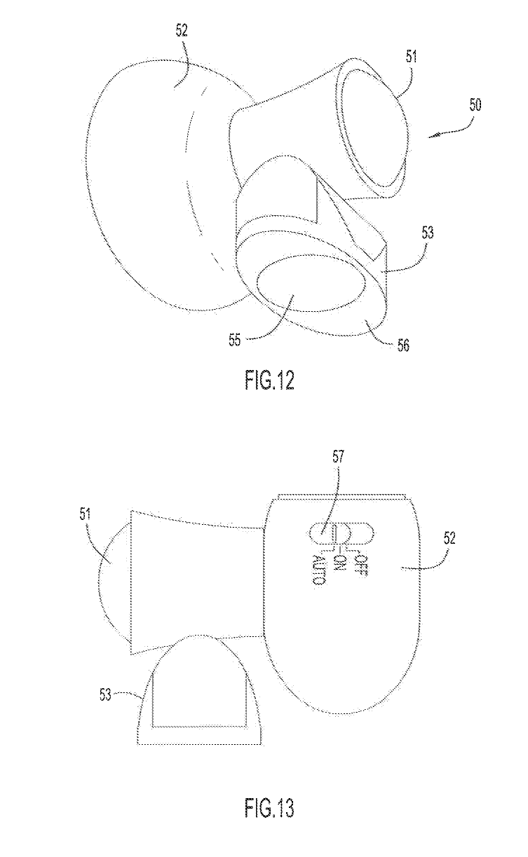

As will now be described with reference to FIGS. 1-11, the bedside lighting device 30 includes preferably a box-like housing 40, typically rectangular or cubic, which encloses a battery powered lighting unit 50 (shown in FIGS. 6, 7 and 10). The lighting unit 50, as shown in FIGS. 12 and 13, includes a built-in motion sensor 51 for activating a light source 52 and keeping the light source 52 activated for as long as motion is being detected within the sensor range. The housing 40 includes a top wall 41, a bottom wall 42, a rear wall 43, a left side wall 44, a right side wall 45, and a front panel 46 rotatably connected at its left edge to the left side wall 44 by a hinge 70 (see FIGS. 1, 4, 6, 7, 10, and 11). The hinge 70 allows the front panel to swing to an open position (see FIGS. 6, 7, 10 and 11) in order to provide access to the interior of the housing 40 to permit installation and removal of the battery powered lighting unit 50, as well as to permit the batteries of the lighting unit to be replaced with fresh batteries once the light output of the lighting unit begins to dim or fail. A standard door-type hinge, such as the one shown in FIG. 1, is the mechanism of choice to provide rotational movement of the front panel 46 since it is not only inexpensive, but may be quickly and easily installed with simple tools. However, any other suitable hinge mechanism that permits the front panel 46 to be pivotably connected and rotated relative to side wall 44 (or side wall 45) may be used. In addition, instead of using only a single hinge, multiple hinges may be used. The hinge may be made from any durable material, such as metal or plastic. Alternatively, but less desirably, the front panel may be totally removed from the housing to provide access to the housing interior.

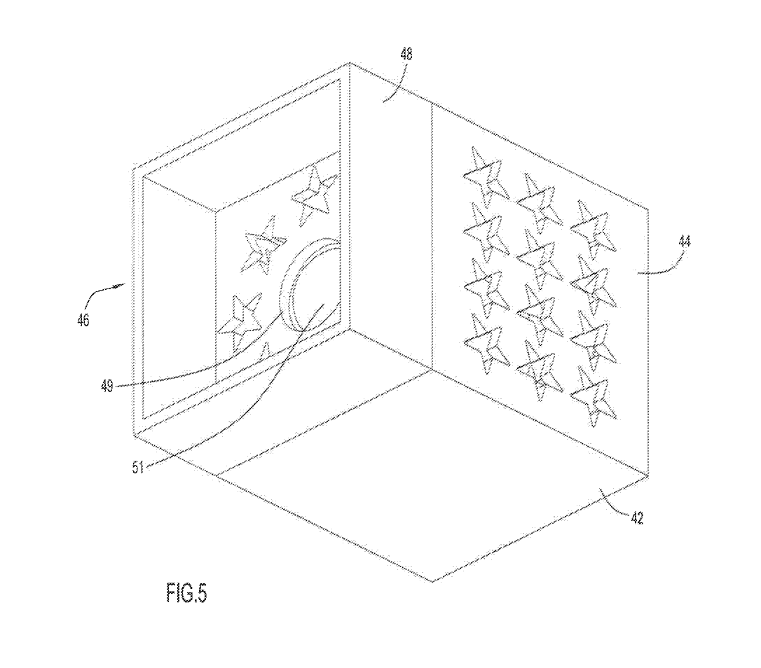

As seen in FIGS. 1-3, multiple openings or light apertures 60 are cut, punched or drilled into the side walls 44, 45, and the rear wall 43 of the housing 40. However, any other suitable method for creating apertures 60 may be employed. While light apertures 60 permit light from the lighting unit 50 to escape from housing 40, the apertures are configured to provide only a low level of illumination on an area of the floor 10 in the vicinity of the lighting device 30 (FIG. 20). Moreover, the light apertures 60 and the position of the lighting unit 50 are designed to prevent upward emission of light that may startle a person or his/her bedmate. Additionally, as seen in FIGS. 1 and 5, neither the top wall 41 nor the bottom wall 42 of the housing 40 is provided with apertures or holes. It is particularly important that top wall 41 not have any apertures or holes in order to avoid having light escape from the housing in an upward direction when the lighting unit 50 is activated since such upwardly directed light may not only startle the user, but may awaken another person sharing the bed. More specifically, as described in greater detail below, light from light source 52 is directed upwardly and then reflected downwardly and transversely from the interior surface of the housing top wall and through light apertures 60 so as to exit housing 40 downwardly and outwardly along the floor.

While the apertures 60 in the side and rear walls of housing 40 are shown as being star-shaped, any other suitable and/or aesthetically pleasing shape may be used. Furthermore, the total area of the openings 60 in the side and rear walls of the housing are from 25% to 75% of the area of the respective wall, preferably around 40% of the area of the respective wall, depending on the amount of emitted light needed for functional and/or aesthetic purposes. The apertures 60 are illustrated as being the same size and shape to facilitate manufacturing, but may differ in size and shape for aesthetic purposes. The location of the apertures 60 in the side and rear walls of housing 40 is a matter of choice. For instance, the apertures may be designed in rows and columns, random patterns, or any other aesthetic pleasing pattern.

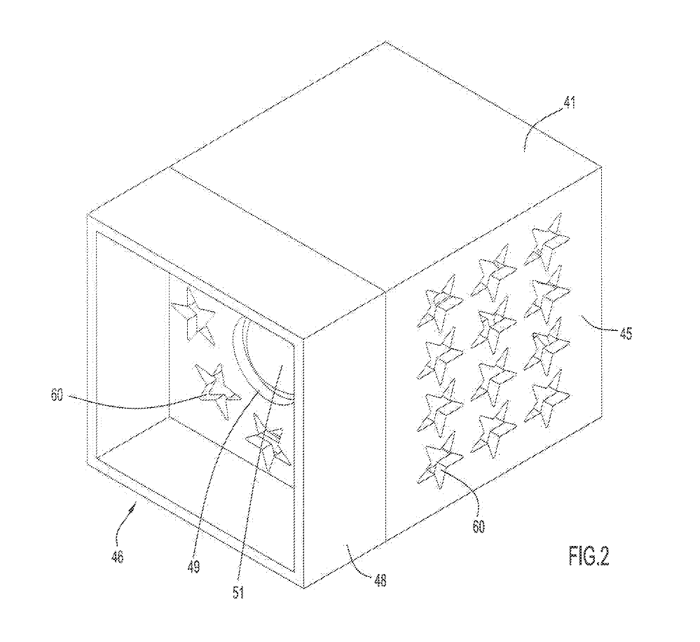

The hinged front panel 46 of the housing 40 comprises an open peripheral frame portion 48 with a flat planar rear wall portion 47 set back from the front peripheral edge of the frame portion. The open frame portion 48, as shown in FIGS. 1, 2, 8, and 9, extends forwardly from and surrounds the flat planar rear wall portion 47. The wall portion 47 includes apertures 60 similar to the apertures in the side and rear walls of housing 40 (see FIGS. 1 and 2). The wall portion 47 further includes a sensor aperture 49 configured to accommodate the motion sensor 51 of the lighting unit 50. The aperture 49 is generally centered in wall portion 47 but may be slightly above center to direct the motion sensor pattern more downwardly. The open frame portion 48 of the front panel 46 focuses the directivity of the motion sensor pattern due to the set back of the wall portion 47 from the front edge of the open frame portion. Specifically, the top overhang provided by frame portion 48 prevents the motion sensing field from dispersing upwardly, and the side extensions of the frame prevent the motion sensing field from dispersing laterally. Thus, the greater the wall portion 47 is set back from the front edge of the frame portion 48, the more the directivity is focused. The rear wall portion 47 preferably is set back about an inch from the front edge of the open frame portion 48, but the set back may vary significantly according to pattern directivity requirements of the user.

Light apertures 60 and the sensor aperture 49 in the front panel 46 are cut, punched, or drilled into wall portion 47. However, any other suitable method may be employed to create the apertures. The light apertures 60 in the wall portion 47 not only permit light from the lighting unit 50 to escape from the housing 40, but provide only a low level of illumination to the floor 10 (FIG. 16) in the vicinity of the lighting device 30. Furthermore, while the light apertures 60 in wall portion 47 are shown as being star-shaped, any other suitable and/or aesthetically pleasing shape may be used. Moreover, the light apertures 60 are illustrated as all being the same size and shape to facilitate manufacturing, but they can differ in size and shape for aesthetic purposes. Also, the location of the apertures 60 in the wall portion 47 is a matter of choice. For instance, the apertures 60 may be designed in rows and columns, random patterns, or any other aesthetic pleasing pattern.

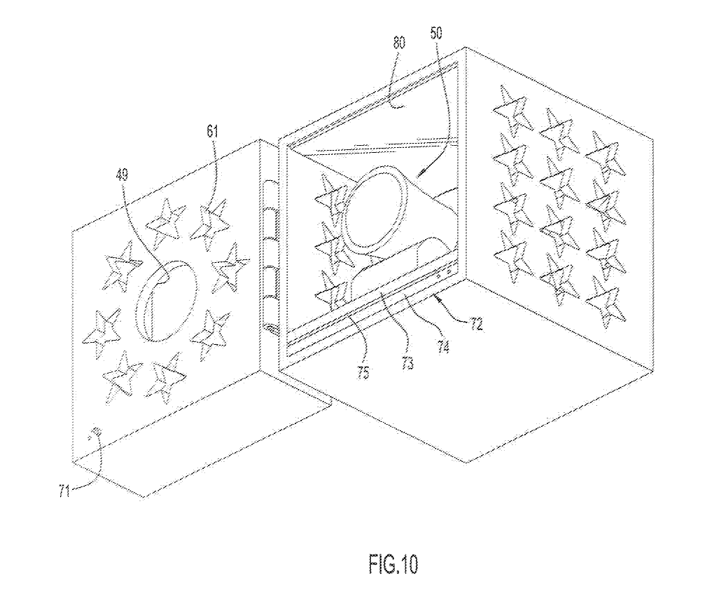

The housing 40 has a reflective surface 80 (FIG. 10), e.g., a mirror or other suitable reflective material, attached to and preferably entirely covering the inside surface of the top wall 41 of housing 40 to redirect light emitted from the lighting unit 50 in a downward angle through the light apertures 60 in the back wall 43, side walls 44, 45, and wall portion 47 of front panel 46, thereby minimizing upwardly directed emitted light while permitting light emission along the floor 10 (see FIG. 16). As depicted in FIGS. 6, 7, 10, and 11, housing 40 further includes a support structure 72 located on the inside surface of bottom wall 42 to securely hold the motion actuated lighting unit 50 in place within the interior of the housing during use. The support structure 72 has a configuration permitting the lighting unit 50 to be easily detached and removed from the interior of housing 40 to replace the lighting unit batteries or when the lighting unit is to be used for another purpose, such as a flashlight.

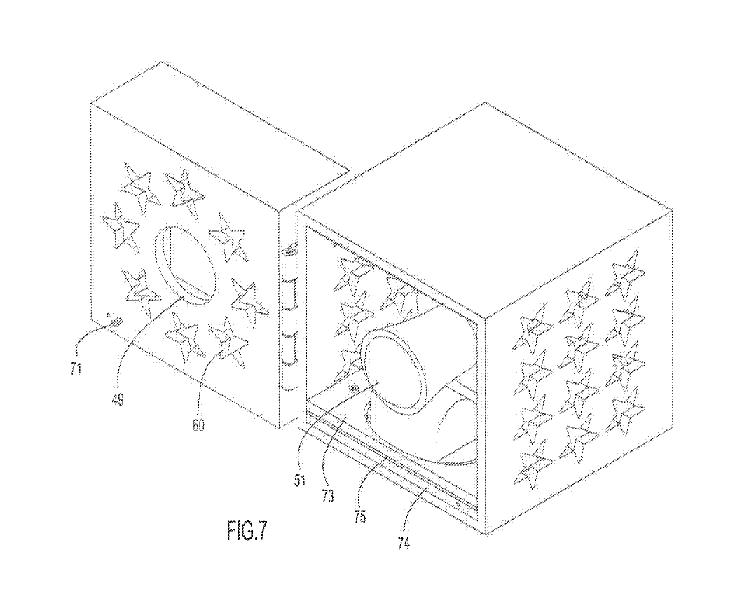

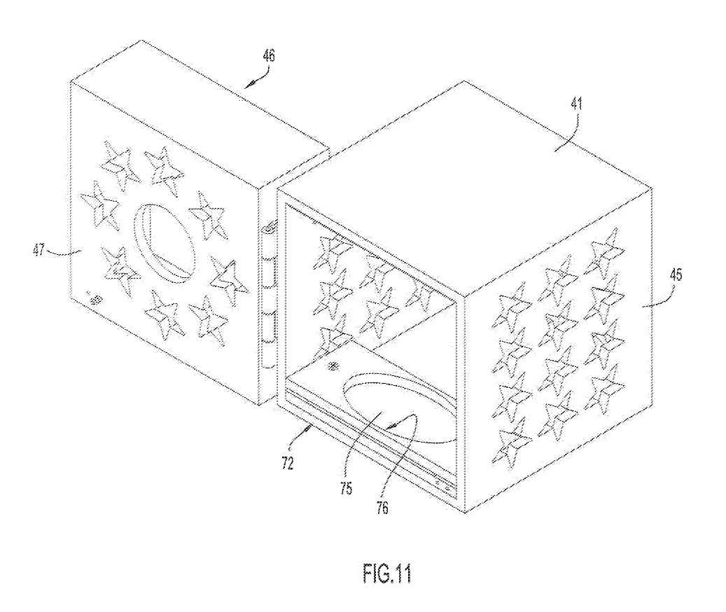

The preferred support structure 72 takes the form of a raised platform comprising an upper support member 73 and a lower support member 74 (FIG. 7). A magnetically permeable metal plate 75 is sandwiched between the upper and lower support members, and the upper support member 73 includes a generally oval-shaped opening 76 extending therethrough to permit access to the recessed metal plate 75 from above (see FIG. 11). The motion actuated lighting unit 50, as shown in FIG. 12, includes a base 53 having an oval shape generally corresponding to the oval shape of the opening 76 in the upper support member 73. However, opening 76 and base 53 may be any other suitable shape, such as circular, square, or oblong, that is consistent with their required functions described herein. A circular mounting magnet 55 is secured to a bottom surface 56 of the base 53 (FIG. 12). However, instead of having the magnet 55 on the bottom surface of the base 53 and the magnetically permeable metal plate 75 sandwiched between the upper and lower support members 73, 74, the positions of the magnet and the metal plate may be reversed. During use, the magnetic attraction between the magnet 55 and the metal plate 74, together with the corresponding shape of base 53 and opening 76, not only holds lighting unit 50 securely in the housing within opening 76, but keeps the motion sensor 51 in alignment with the sensor aperture 49 in the rear wall portion 47, and the light source 52 directed towards the reflective surface 80 so that the emitted light may be redirected by the reflective surface in a downward angle through the apertures 60 in the housing. Alternatively, the lighting unit 50 may be removably held in place by any other suitable quick fastener method so long as the lighting unit is not only securely fastened within the housing 40, but easily removable from the housing in an emergency or to replace the batteries. Additionally, the housing 40 and the support structure 72 for the lighting unit 50 are preferably made from wood, e.g., pine, but could be made from plastic, aluminum, or other non-magnetically permeable material—unless the lighting unit 50 is secured in place by means other than magnetic attraction.

Wall portion 47 further includes a locking mechanism 71 which securely holds front panel 46 in a closed position. The locking mechanism 71, as depicted in FIGS. 1, 6, and 10, is a simple screw which extends through at least one small diameter hole in a lower corner of the wall portion 47 that aligns with a similar threaded hole in the lower support member 74 of housing 40. In addition to securing the front panel 46 in its closed position, the screw functions to child-proof the lighting device 30 by making it difficult for small children to gain easy access to lighting unit 50 in the interior of the housing 40. In order to provide effective and adequate child-proofing, the screw needs to be only thumb tight. However, enhanced child-proofing may be obtained by more securely tightening the screw with a screwdriver. It should be appreciated, however, that in lieu of a screw, any other suitable removable locking mechanism may be used to maintain the front panel 46 in its closed position in a child-proof manner.

The lighting unit 50 further includes a switch mechanism 57 (see FIG. 13) which is slidable to three different positions—an off position, an on position wherein the light is constantly on (On Mode), and an auto position wherein the light is turned on in the dark only when the motion sensor 51 detects motion (Auto Mode). Furthermore, when the switch mechanism 57 is in the On Mode, the lighting unit 50 may be used as a flashlight in the event of an emergency. The lighting unit 50 may include a light detector that precludes the lighting unit from emitting light if the ambient light is above a predetermined level. A suitable commercially available lighting unit for use in the bedside and pathway lighting system of the invention is the Sylvania® “Motion Activated Battery Powered Safety Light”—SL72178.

As part of the night lighting system of the present invention, an additional destination motion sensing lighting unit 90 is provided which serves as a light-responsive night light and an emergency lighting unit. The destination lighting unit 90 is adapted to plug into a wall mounted electrical outlet in a bathroom (or any other room) so as to normally operate on a. c. convenience power (see FIG. 20). The light-sensing portion of the destination lighting unit 90 functions to illuminate the bathroom area in the manner of a conventional night light. The destination lighting unit 90 preferably provides a relatively dim illumination field and, when cooperating with the bedside lighting device 30 and/or the other described pathway lighting devices 30 of the night lighting system of the present invention, has numerous advantageous features. For instance, once the bathroom environment becomes sufficiently dark to automatically actuate the night light feature, the resulting low level illumination intensity is designed to be adequate to simply allow a person to negotiate the bathroom and use the facilities as necessary without turning on the relatively bright light fixture(s). An additional feature of the bathroom or destination lighting unit 90 is the inclusion of a brighter emergency light source located in the unit, typically in the form of plural LED lamps. The emergency light emitted by the unit is powered by an internal re-chargeable battery which is charged by the a. c. power source. The emergency light is automatically activated when the a. c. convenience power is interrupted. The battery operated emergency light may also be used as a flashlight by removing the unit from the electrical receptacle and actuating a switch on the unit. Should it be necessary to evacuate the premises, the flashlight provides bright light for several hours (e.g., over five hours if fully charged) to assist with departure. Should evacuation not be desired, the emergency light can remain on until a. c. power is restored, thereby illuminating the desired area. A suitable commercially available single unit serving both the night light and emergency lighting functions is the Sylvania® “Power Failure 3-in-1 Light”—SL72032.

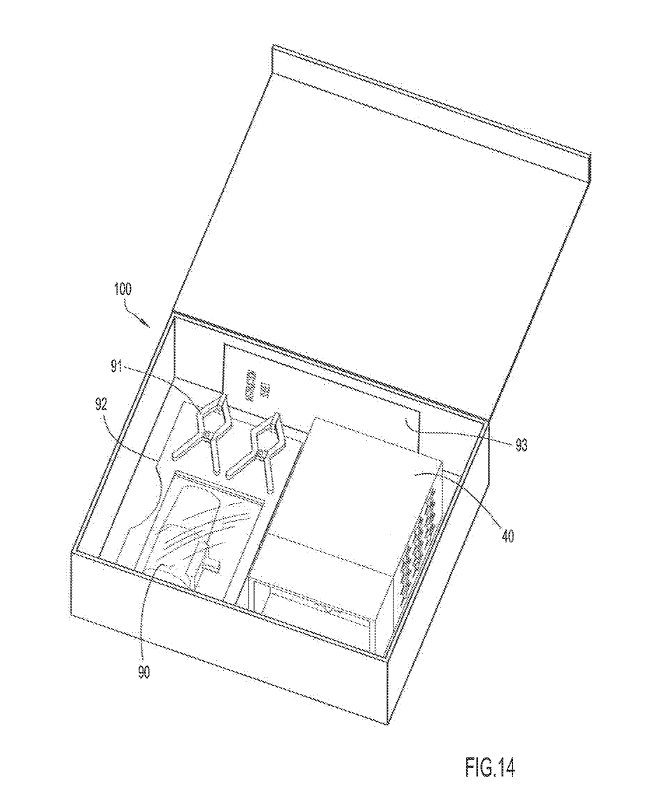

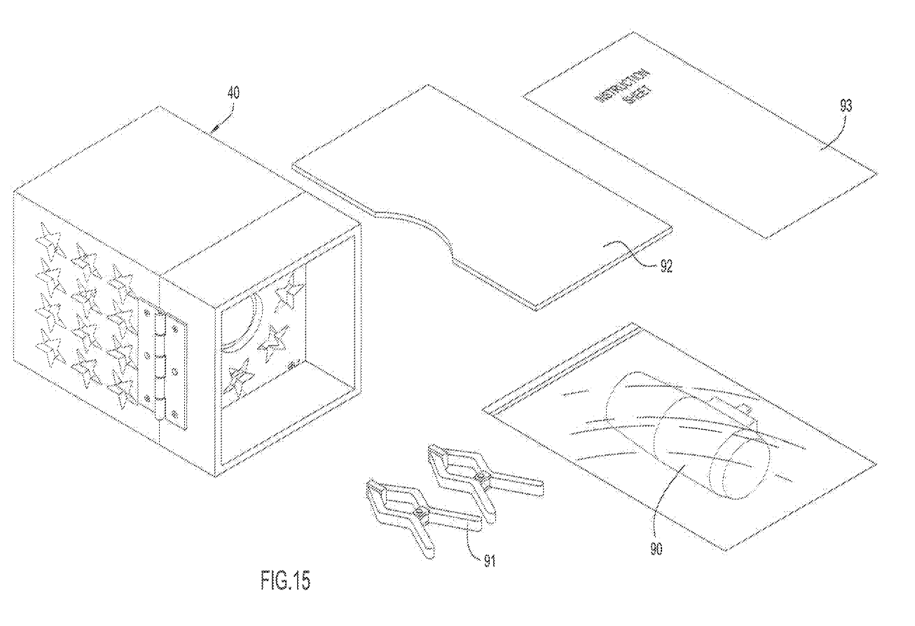

The night lighting system components described above may be available individually, or packaged as a kit, as illustrated in FIG. 14. Specifically, the kit 100 includes the motion activated lighting device 30 (i.e., the housing 40 together with the lighting unit 50 and its motion sensor 51 installed in the housing) and the destination motion sensing lighting unit 90. However, the kit may be packaged with more than one motion activated lighting device 30 (including lighting unit 50 with its built-in motion sensor 51) depending on the requirements of the user. For instance, additional motion activated lighting devices 30 with lighting units and built-in motion sensors may be provided in the kit for deployment along a pathway in situations where the path to a bedroom or bathroom involves turns or bends such that portions of the path are not illuminated by the bedside lighting device(s) alone.

Additionally, the kit may further include a plurality of clips 91, which may be conventional clothespins or the like, a bag 92 for each of the lighting units 50, 90, and an instruction sheet 93. The clips are included in the kit to enable a person to close off any gap between curtains or drapes that keep them from closing sufficiently tight to prevent outside light from entering the room. A reminder card is placed within each of the bags 92 to encourage users to not forget to take the lighting units with them when they leave home for a hotel stay and when leaving the hotel so as to not leave the units behind. While not totally necessary, the bags 92 will make the lighting units 50, 90 just a little bit easier to be compatible with other items in a suitcase of the traveler. The instruction sheet 93 may include instructions for operating the lighting units 50, 90 and illustrations of suggested locations for placement of the lighting devices 30.

The night lighting system of the present invention has numerous advantages. For instance, the kit components eliminate the “fumble factor” that often arises when one is in an unfamiliar environment and has to get up at night. Not only must one find the bedside lamp in the dark, but he/she must also find the lamp on/off switch, which can be in many different locations on different lamp designs. Moreover, although lighting in the room is desired, the amount of light usually offered by the bedside lamp is a lot more than one typically needs, or wants, to simply get to the bathroom. The battery operated bedside lighting device used in the present invention is limited to illuminating the floor as its field of illumination is restricted by the redirection of the light from the lighting unit at a downward angle by the reflective surface on the inside of the top wall of the housing, and by the configuration of the light apertures in the rear wall, the side walls, and the wall portion of the front panel of the housing. The field of emitted light is typically circular-shaped and muted but quite sufficient to enable one to see where he/she is going (FIG. 20). Continued motion (i.e., walking) will keep the motion sensor activated to keep the lighting unit on as long as someone is moving within the sensor's range which is typically between ten and fifteen feet. Once one has gotten within range of the bathroom with its open door and the additional night light, which is constantly on at night, the person will be able to easily navigate his/her way into and around the facility. Here again, users are greeted with low intensity light, thus reducing the amount of “waking up” that they will experience.

Further, the night lighting system provided by the kit of the present invention offers not only the chance to get a better night's sleep, but the ability to get up at night without disturbing a sleeping partner as the emitted light is of low intensity and its illumination field is low to the ground. There is also the comfort of knowing there is a safety system already in place, ready for an emergency. It must be noted that the lighting unit of the motion activated lighting devices can also be used as a flashlight by removing the lighting unit from the housing and moving the switch to the on position (On Mode). Last but not least, there is a savings of energy as the lights use far less electricity than conventional lamps or ceiling light fixtures when performing their intended functions. Both are turned off when there is enough light that they are not needed. This light can come from either another light source or daylight.

The motion sensor portion of unit 50 is conventional of itself and may be of the active type (e.g., transmitting and receiving reflected acoustic, optical, microwave, etc., energy) or passive type (e.g., sensing heat, light, sound, etc. emanating from sensed objects). The light emitting portion of the unit is also, of itself, conventional and may be an LED unit or any other light source that emits light of sufficient intensity to illuminate a path for a person in an otherwise darkened room but insufficient to startle persons awakening in such a room; this intensity is typically in the range of ten to forty lumens. As in the preferred embodiment, it is preferred that the light emitter portion and its controlling motion sensor be part of the same unit, such units being commercially available in a variety of models. However, if more convenient for some embodiments, the light emitter and its controlling motion sensor may be physically separate but electrically connected.

The housing 40, although ideally in the form of a rectangular parallelepiped, or more limitedly a cube, can take any shape, regular or irregular, that is consistent with its required functions described herein which are primarily: (a) directing light from interiorly of the housing in a downward and outward direction; and (b) sensing motion exteriorly of the housing in a limited field or area along a floor or surface on which the housing is placed. The housing should preferably be such as to prevent children and pets from gaining access to its interior components and should be capable of being stably placed on a floor or similar surface when in use.

Although in the preferred embodiment the wall portion 47 of the housing is flat or planar, it is understood that it can be concave, convex or otherwise configured for aesthetic or other purposes as long as it is capable of permitting/providing the functions described herein. Similarly, and with the same restrictions, the other walls of the housing need not be flat rectangles but instead can be otherwise contoured and configured.

It should be understood that the system of the present invention is not restricted to use in a hotel or other unfamiliar environment. On the contrary, the system may be used in a user's own home to great advantage. In addition, use of the kit components in the homes of elderly people is quite advantageous to them. The system is also advantageous to infirm or impaired individuals, and is extremely comforting to small children who get up in the middle of the night and are afraid of the dark.

Although specific commercially available lighting units have been described herein for use in the system, any lighting units capable of providing the described functions may be employed. It must also be understood that different individuals have different needs for illumination. Thus, while the lighting units in the kit of the invention will be sufficient for most consumers, each consumer should be free to experiment and make certain his or her lighting requirements are met. If there is not enough light or too much light is provided by the components in the kit, the consumer could supplement or replace a part or parts of the motion activated lighting units to provide light wherever it is needed and at the desired intensity.

As mentioned previously, the detection area of coverage for the motion sensor of the motion activated lighting unit has a range up to about fifteen feet. Therefore, it must be understood that the path or coverage area of the motion sensor must be unobstructed to allow it to function properly. Thus, if the motion detector is placed under a bed, the bed cannot have a skirt or low hanging blankets which would interfere with the motion sensor's detection area coverage. However, should either of these bedding accessories be used, the unique housing for the lighting device described herein permits the device to be placed substantially anywhere and it will not throw light upwardly.

Moreover, whenever more than one motion activated lighting device is used, it is advisable to set the motion sensors of the lighting devices so that one lighting device may be activated for a long enough time to enable a person to reach the activation range of the other lighting device, thus providing continuous light for walking through the room. This described activation program works for both going to and returning from the bathroom and the exit to the bedroom.

Again, the purpose of the night lighting system of the present invention is to provide adequate lighting that is hands free activated and is of a low enough intensity so as to not startle the user with a blast of light or awake a second person sharing the bed. The “non startle awakening principal” is also applicable to the destination lighting unit in the bathroom. Moreover, the entire motion activated lighting arrangement of this invention not only promotes a better night's sleep, it promotes energy savings by reducing the need for using conventional a.c. power to activate general room lighting.

Having described preferred embodiments of a new and improved motion activated lighting device, system, and kit for use by persons in dark unfamiliar environments, it is believed that other modifications, variations, and changes will be suggested to those skilled in the art in view of the teachings set forth herein. It is therefore to be understood that all such variations, modifications, and changes are believed to fall within the scope of the invention as defined by the appended claims. Although specific terms are employed herein, they are used in a generic and descriptive sense only and not for purposes of limitation.

What is claimed is:

1. Apparatus for responding to motion by a person in a darkened room environment by providing sufficient light to enable that person to negotiate the environment, said apparatus comprising:
a housing having a top, bottom, front, rear, and left and right sides, wherein at least the front and the left and right sides of the housing are provided with light apertures for permitting light from inside the housing to pass therethrough:
a light source disposed within the housing; and
a motion sensor disposed inside the housing,
wherein the light source and motion sensor are electrically connected such that the light source is turned on only when motion is detected by the motion sensor in the darkened room environment, and
wherein a sensor aperture is defined through one of said front, rear, left or right sides to permit a sensing field to be defined exteriorly of said housing for said motion sensor.

2. The apparatus of claim 1,
wherein said top, bottom, front, rear, and left and right sides are defined by respective top, bottom, front, rear, and left and right side walls;
wherein said top wall has a light reflective interior surface and said light source is oriented inside said housing to direct its emitted light onto said reflective interior surface; and
wherein said reflective interior surface redirects the emitted light in a downward angle through said light apertures to provide low level illumination on a floor surface in the vicinity of housing.

3. The apparatus of claim 2, wherein said light apertures and the orientation of said light source are configured to prevent upward emission of light within the darkened room environment.

4. The apparatus of claim 2,
wherein said reflective interior surface is a mirror which entirely covers the inside surface of the top wall, and
wherein the emitted light from said light source is directed upwardly towards said mirror and then reflected downwardly and transversely through said light apertures so as to exit the housing downwardly and outwardly along the floor surface.

5. The apparatus of claim 1,
wherein the front of the housing is defined by a front panel connected to one of the housing sides, the front panel comprising an open peripheral frame portion with a rear wall portion set back from an edge of the front peripheral frame portion.

6. The apparatus of claim 5,
wherein said sensor aperture is defined through said rear wall portion, and
wherein said frame portion focuses the motion sensing field of the motion sensor in a direction which is only along a floor surface of the darkened room environment.

7. The apparatus of claim 5, wherein said open peripheral frame portion extends forwardly from and surrounds the rear wall portion and includes:
a top overhang which prevents the motion sensing field from dispersing upwardly exteriorly of said housing, and
side extensions which prevent the motion sensing field from dispersing laterally exteriorly of said housing.

8. The apparatus of claim 2, wherein said housing further includes support structure in the form of a raised platform located on an inside surface of the bottom wall to securely hold the light source in place within the interior of the housing.

9. The apparatus of claim 8, wherein said support structure comprises one of a magnetically permeable metal plate and a magnet sandwiched between an upper support member and a lower support member.

10. The apparatus of claim 9,
wherein said upper support member includes an opening extending therethrough to provide access to said metal plate or said magnet recessed beneath the upper support member.

11. The apparatus of claim 9,
wherein the light source further includes a base having one of a magnet and a magnetically permeable metal plate secured to a bottom surface of the base, and
wherein the base has a configuration which fits within said opening so that magnetic attraction between the magnet and the metal plate holds the light source securely in the housing within the opening.

12. The apparatus of claim 10,
wherein said light source and the motion sensor form a single battery powered motion actuated lighting unit, and
wherein the magnetic attraction holds said lighting unit securely in place within the opening such that the motion sensor is aligned with the sensor aperture and light from the lighting unit is directed towards said reflective surface.

13. The apparatus of claim 5,
wherein said front panel is pivotally connected to one of the housing sides and is rotatable between an open position to provide access to the interior of said housing and a closed position, and
wherein said rear wall portion includes a locking mechanism to securely hold the front panel in its closed position.

14. The apparatus of claim 13,
wherein said rear wall portion has at least one hole extending though a lower portion thereof that aligns with a similar hole in the lower support member,
wherein said locking mechanism extends through the hole in said wall portion and engages said hole in the lower support member to secure the front panel of said housing in its closed position, and
wherein the engagement of said locking mechanism with said hole in the lower support member functions to effectively child-proof the housing by making it difficult to gain easy access to the light source disposed within the interior of the housing.

15. A lighting system for responding to motion by a person in a darkened room environment by providing sufficient light to enable that person to negotiate the environment, said system comprising:
a first apparatus as defined in claim 1, wherein said first apparatus is positioned on a floor surface under or adjacent a side of a bed such that the motion sensor, in response to detected motion of a person placing a foot on or near the floor surface of the darkened room environment, activates the light source to provide low level illumination of the floor surface near and beyond the side of the bed.

16. The lighting system of claim 15, further comprising a second apparatus as defined in claim 1:
wherein the second apparatus is positioned on the floor surface in close proximity to said first apparatus such that the motion sensor of said second apparatus, in response to detected motion of a person walking along the floor surface of the darkened room environment, activates its light source to provide a low to the floor illuminated path from the bed to another location in the darkened room environment, and
wherein the motion sensor of the first apparatus and the second apparatus keeps the light source of its respective apparatus activated only as long as motion is detected within the sensor's defined sensing field.

17. The lighting system of claim 18, further comprising an additional destination motion sensing lighting unit, wherein the lighting unit is adapted to plug into an electrical outlet at the another location and serve as a light-responsive night light when the environment becomes sufficiently dark and an automatically activated emergency lighting unit when a.c. power is interrupted.

18. A lighting kit, comprising:
at least one apparatus as defined in claim 1 to provide low level illumination along a floor surface in a darkened room environment in response to detected motion; a destination motion sensing lighting unit adapted to plug into an electrical outlet at a location in the environment and serve as a light-responsive night light when the environment becomes sufficiently dark and an automatically activated emergency lighting unit when a.c. power is interrupted;
clips to enable a person to close off any gap between curtains to prevent outside light from entering the environment;
bags for storing the at least one apparatus and the destination lighting unit when not is use; and
an instruction sheet which includes instructions for operating the at least one apparatus and the destination lighting unit, and illustrations of suggested placement locations for the at least one apparatus in the environment.

19. The kit of claim 18, further comprising a second apparatus as defined in claim 1 to provide additional low level illumination along a floor surface in the darkened room environment in response to detected motion.

20. A motion activated night lighting device, comprising:
a housing including a front panel pivotally connected to said housing; and
a battery powered lighting unit including a built-in motion sensor disposed within the housing;
wherein the front panel comprises:
an open peripheral frame portion with a rear wall portion set back from an edge of the open peripheral frame portion, said rear wall including a sensor aperture generally centered therein for accompanying said built-in motion sensor, and
multiple light apertures surrounding the sensor aperture configured to permit light emitted from the lighting unit to escape from the housing to provide a low level of illumination along a floor surface, and
wherein the sensor aperture permits a sensing field to be defined exteriorly of said housing for said motion sensor such that, in response to detected motion within said sensing field, the motion sensor activates the lighting unit to provide said low level of illumination along the floor surface.
